(19) United States
(12) Patent Application Publication
(10) Pub. No.: US 2025/0005256 A1
(43) Pub. Date: Jan. 2, 2025

(54) STANDARD CELL TOPOLOGY WITH POWER/PERFORMANCE/AREA OPTIMIZATION

(71) Applicant: MEDIATEK INC., Hsin-Chu (TW)

(72) Inventors: Ho-Chieh Hsieh, Hsinchu City (TW); Kin-Hooi Dia, Hsinchu City (TW)

(73) Assignee: MEDIATEK INC., Hsin-Chu (TW)

(21) Appl. No.: 18/732,655

(22) Filed: Jun. 4, 2024

Related U.S. Application Data
(60) Provisional application No. 63/523,626, filed on Jun. 27, 2023.

(51) Int. Cl. G06F 30/398; G06F 30/392; G06F 119/06

(52) U.S. Cl. CPC G06F 30/398; G06F 30/392; G06F 2119/06

(57) ABSTRACT

The present invention provides a method for placing and routing a circuit design on an integrated circuit. The method includes the steps of: placing a plurality of standard cells in the circuit design; searching for the standard cells with power-to-power abutment in the circuit design; and performing an operation on the standard cells with the power-to-power abutment for a power/performance/area optimization.

### CROSS REFERENCE TO RELATED APPLICATIONS

This application claims the benefit of U.S. Provisional Application No. 63/523,626, filed on Jun. 27, 2023. The content of the application is incorporated herein by reference.

### BACKGROUND

Power, performance and area (PPA) are three variables used in deciding how to optimize semiconductor designs. When the PPA optimization is performed, a designer generally needs to design and deliver one or more customized new cells in the placement and routing stage of the chip design. However, designing customized new cells for the placement and routing stage is inefficiently.

### SUMMARY

It is therefore an objective of the present invention to provide a placement and routing method of chip design, which can perform PPA optimization by modifying some standard cells without creating new cells, to solve the above-mentioned problems.

According to one embodiment of the present invention, a method for placing and routing a circuit design on an integrated circuit comprises the steps of: placing a plurality of standard cells in the circuit design; searching for the standard cells with power-to-power abutment in the circuit design; and performing an operation on the standard cells with the power-to-power abutment for a power/performance/area optimization.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for placing and routing a circuit design on an integrated circuit according to one embodiment of the present invention.

FIG. 2 is a diagram illustrating a cell level of the source-source merging operation according to one embodiment of the present invention.

FIG. 3 is a diagram illustrating a chip level of the source-source merging operation according to one embodiment of the present invention.

FIG. 4 is a diagram illustrating the power and/or enhancement operation according to one embodiment of the present invention.

FIG. 5 is a diagram illustrating the diffusion break removal according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

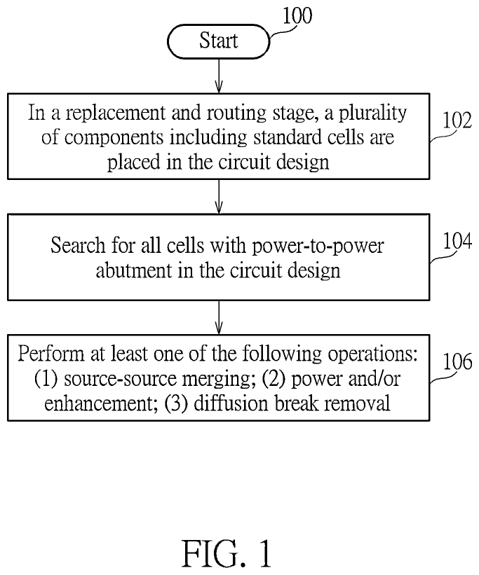

FIG. 1 is a flowchart of a method for placing and routing a circuit design on an integrated circuit (IC) according to one embodiment of the present invention. In Step 100, the flow starts. In Step 102, the circuit design is in a replacement and routing stage, and a plurality of components including standard cells are placed in the circuit design. Specifically, a conventional design process begins with the creation of the design. The design specifies the function of a circuit at a schematic or logic level and may be represented using various hardware description languages (e.g., VHDL, ABEL, or Verilog) or schematic capture programs. The design is synthesized to produce a logical network list “netlist”, and the synthesized design is mapped onto primitive components within the target device. Then, placement of the components of the synthesized and mapped design is performed for the target device. During placement, each mapped component of the design is assigned to a physical position on the device. The placer attempts to place connected design objects in close physical proximity to one another in order to conserve space and increase the probability that the required interconnections between components will be successfully completed by the router.

In Step 104, the circuit design system searches for all cells with power-to-power abutment in the circuit design. Specifically, the cell such as the standard cell generally comprises at least one metal-oxide-semiconductor field-effect transistor (MOSFET), and a first electrode of the MOSFET such as a source electrode may couple to a power node providing supply voltage (i.e., VDD) or a ground voltage, and a second electrode of the MOSFET such as a drain electrode may be used for receiving or transmitting data signal. In this embodiment, the power-to-power abutment indicates that the first electrodes of two adjacent cells are adjacent to each other, that is, the cell with power-to-power abutment indicates that the cell has the first electrode which abuts the first electrode of another cell. In the following description, because a standard cell having an inverter is used as an example, a source-to-source abutment is used to represent the power-to-power abutment.

In Step 106, the circuit design system performs at least one of the following operations for the PPA optimization: (1) source-source merging; (2) power and/or enhancement; (3) diffusion break removal.

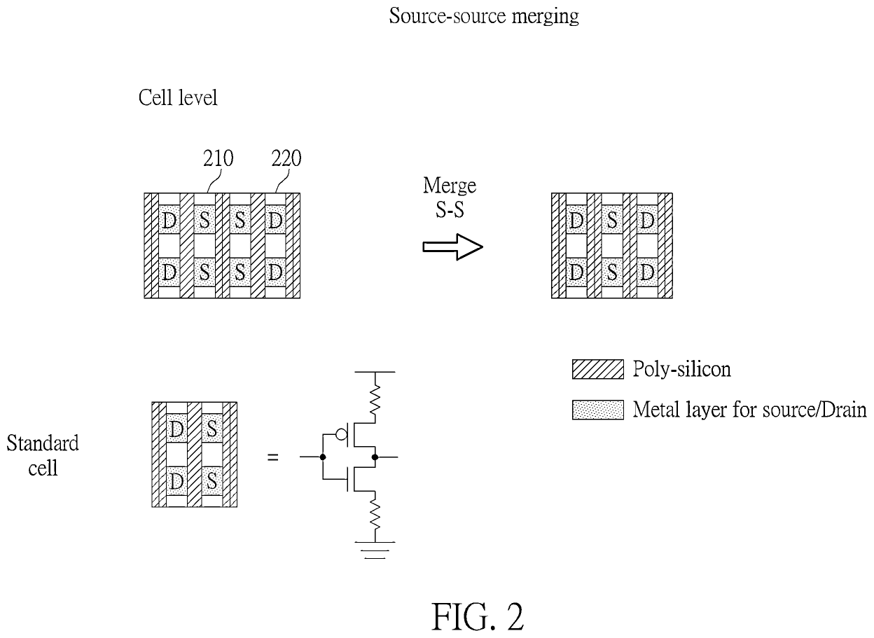

FIG. 2 is a diagram illustrating a cell level of the source-source merging operation according to one embodiment of the present invention. As shown in FIG. 2, the standard cell comprises an inverter including an N-type MOSFET and a P-type MOSFET, and for simplicity, the figure only shows a poly-silicon layer and a metal layer for the source/drain electrodes, wherein “D” in the figure indicates the drain electrode, and “S” in the figure indicates the source electrode. In FIG. 2, each of the standard cells 210 and 220 has the source electrode abutting the source electrode of the adjacent standard cell, so the source electrodes of the standard cells 210 and 220 are merged to reduce the chip area (i.e., the modified two cells share the same merged source electrodes).

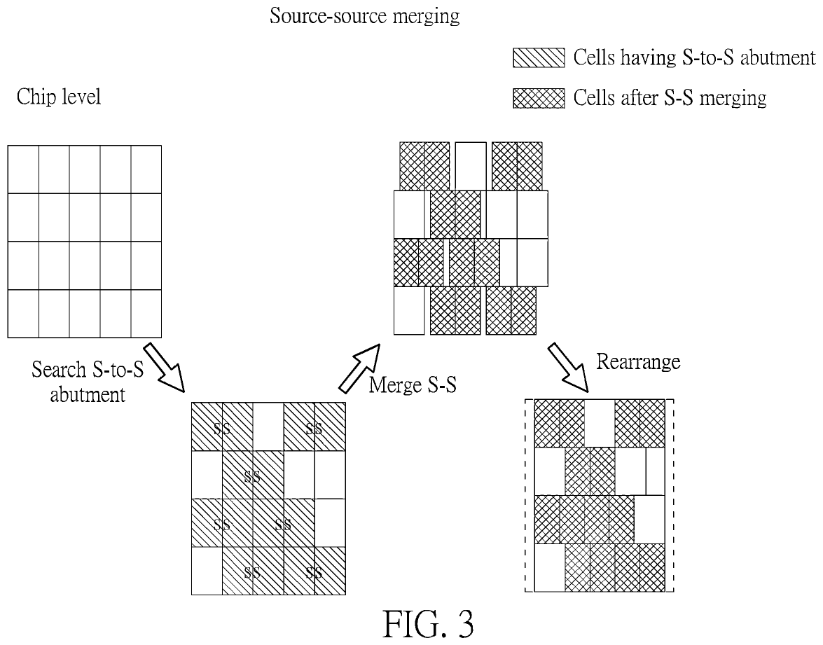

FIG. 3 is a diagram illustrating a chip level of the source-source merging operation according to one embodiment of the present invention. Referring to FIG. 2 and FIG. 3 together, when all the cells with source-to-source abutment are processed under the source-source merging operation, the area of the cells with source-to-source abutment will be decreased, so overall chip area of the circuit design can be greatly reduced after rearranging the cells.

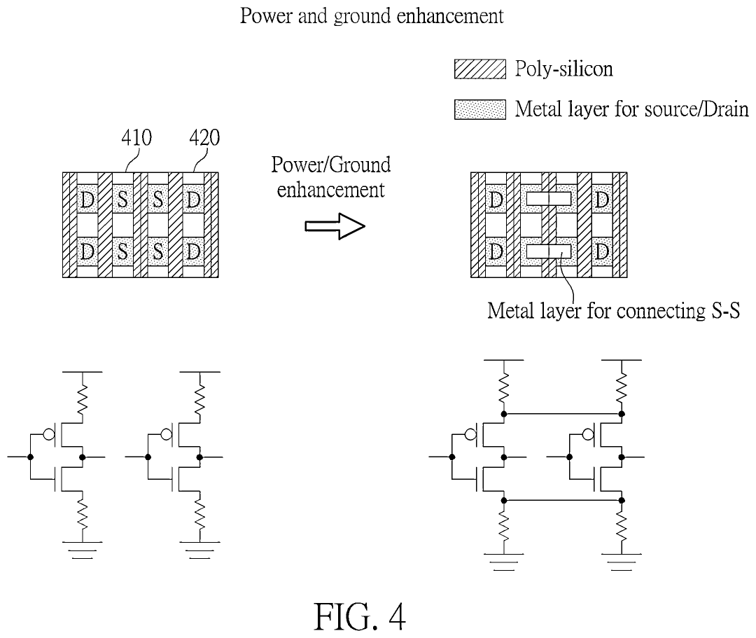

FIG. 4 is a diagram illustrating the power and/or enhancement operation according to one embodiment of the present invention. As shown in FIG. 4, the standard cell comprises an inverter including an N-type MOSFET and a P-type MOSFET. In FIG. 4, each of the standard cells 410 and 420 has the source electrode abutting the source electrode of the adjacent standard cell, so the circuit design system uses another metal layer to electrically connect the source electrodes of the standard cells 410 and 420 (e.g., through via holes), to lower the resistance between the supply voltage and the source electrodes, and to lower the resistance between the ground voltage and the source electrodes.

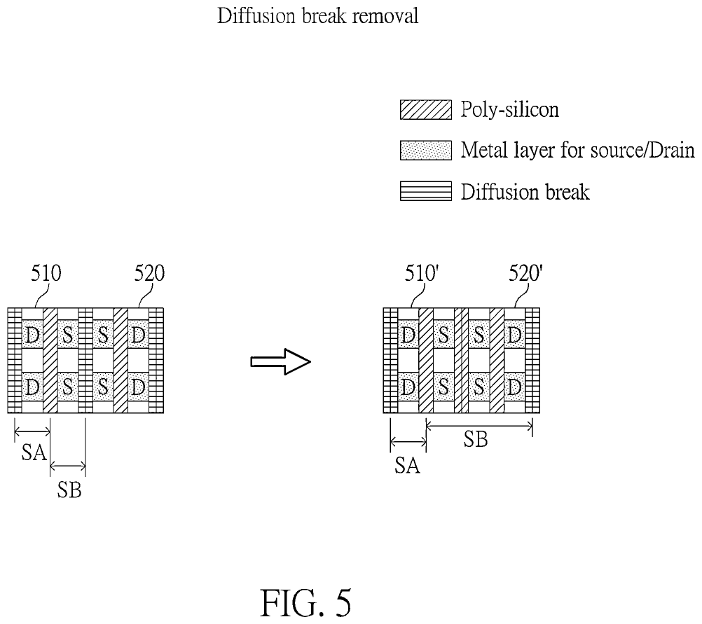

FIG. 5 is a diagram illustrating the diffusion break removal according to one embodiment of the present invention. In some standard cells, a diffusion break is made at the edges of the standard cell to prevent the source electrode in the standard cell from forming an active component with the drain electrode of the adjacent standard cell. The diffusion break is generally called an oxide definition edge (CPODE) pattern, and the diffusion break serving as the insulating region can be manufactured by using silicon oxide, silicon nitride or silicon oxynitride. In FIG. 5, because each of the standard cells 510 and 520 has the source electrode abutting the source electrode of the adjacent standard cell, the diffusion break between the source electrodes of the standard cells 510 and 520 is no longer needed and can be removed. Therefore, the circuit design system can modify the standard cells 510 and 520 to remove the diffusion break between the standard cells 510 and 520, to generate the modified cells 510′ and 520′ (it is noted that the modified cell 510′ still has the diffusion break at the left side, and the modified cell 510′ still has the diffusion break at the right side).

The current of the P-type MOSFET is dependent on the length of diffusion (LOD), such as SA and SB shown in FIG. 5. In the standard cells 510 and 520, the current is limited due to the short length of diffusion; and the modified cells 510′ and 520′ will have larger current because the length of diffusion is increased by removing the diffusion break.

Briefly summarized, in the method for placing and routing a circuit design of the present invention, by searching for the standard cells with power-to-power abutment in the circuit design and performing an operation on the standard cells with the power-to-power abutment for a power/performance/area optimization, the engineer does not need to create customized new cells, so the design efficiency can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for placing and routing a circuit design on an integrated circuit, comprising:
placing a plurality of standard cells in the circuit design;
searching for the standard cells with power-to-power abutment in the circuit design; and
performing an operation on the standard cells with the power-to-power abutment for a power/performance/area optimization.

2. The method of claim 1, wherein the standard cell comprises at least a metal-oxide-semiconductor field-effect transistor (MOSFET), and a first electrode of the MOSFET is coupled to a power node providing a supply voltage or a ground voltage, and a second electrode of the MOSFET is used for receiving or transmitting data signal; and the standard cell with the power-to-power abutment indicates that the standard cell has the first electrode which abuts the first electrode of another cell.

3. The method of claim 2, wherein the step of performing the operation on the standard cells with the power-to-power abutment for the power/performance/area optimization comprises:
for a first standard cell having the first electrode abutting the first electrode of a second standard cell, merging the first electrodes of the first standard cell and the second standard cell.

4. The method of claim 3, wherein the first standard cell and the second standard cell share the merged first electrode.

5. The method of claim 2, wherein the step of performing the operation on the standard cells with the power-to-power abutment for the power/performance/area optimization comprises:
for a first standard cell having the first electrode abutting the first electrode of a second standard cell, using a metal layer to electrically connecting the first electrode of the first standard cell to the first electrode of the second standard cell.

6. The method of claim 2, wherein a first standard cell has the first electrode abutting the first electrode of a second standard cell, and there is a diffusion break between the first standard cell and a second standard cell; and the step of performing the operation on the standard cells with the power-to-power abutment for the power/performance/area optimization comprises:
removing the diffusion break between the first standard cell and the second standard cell.

7. The method of claim 1, wherein the standard cell comprises an inverter comprising a P-type MOSFET and an N-type MOSFET; a source electrode of the P-type MOSFET is coupled to a supply voltage, a source electrode of the N-type MOSFET is coupled to a ground voltage, and a drain electrode of the P-type MOSFET is coupled to a drain electrode of the N-type MOSFET; and the standard cell with the power-to-power abutment indicates that the standard cell has the source electrode which abuts the source electrode of another cell.

8. The method of claim 7, wherein the step of performing the operation on the standard cells with the power-to-power abutment for the power/performance/area optimization comprises:
for a first standard cell whose source electrodes of the P-type MOSFET and the N-type MOSFET are coupled to source electrodes of the P-type MOSFET and the N-type MOSFET of a second standard cell, merging the source electrodes of the P-type MOSFETs of the first standard cell and the second standard cell, and merging the source electrodes of the N-type MOSFETs of the first standard cell and the second standard cell.

9. The method of claim 8, wherein the first standard cell and the second standard cell share the merged source electrodes of the P-type MOSFETs of the first standard cell and the second standard cell, and the first standard cell and the second standard cell share the merged source electrodes of the N-type MOSFETs of the first standard cell and the second standard cell.

10. The method of claim 7, wherein the step of performing the operation on the standard cells with the power-to-power abutment for the power/performance/area optimization comprises:
for a first standard cell whose source electrodes of the P-type MOSFET and the N-type MOSFET are coupled to source electrodes of the P-type MOSFET and the N-type MOSFET of a second standard cell, using a metal layer to electrically connecting the source electrodes of the P-type MOSFETs of the first standard cell and the second standard cell, and using the metal layer to electrically connecting the source electrodes of the N-type MOSFETs of the first standard cell and the second standard cell.

11. The method of claim 7, wherein a first standard cell has the P-type MOSFET and the N-type MOSFET whose source electrodes are coupled to source electrodes of the P-type MOSFET and the N-type MOSFET of a second standard cell, respectively, and there is a diffusion break between the first standard cell and a second standard cell; and the step of performing the operation on the standard cells with the power-to-power abutment for the power/performance/area optimization comprises:
removing the diffusion break between the first standard cell and the second standard cell.
